(19) United States
(12) Patent Application Publication
(10) Pub. No.: US 2016/0247018 A1
(43) Pub. Date: Aug. 25, 2016

(54) SERIAL NUMBER BASED CURRENCY-OWNER IDENTIFICATION

(71) Applicant: International Business Machines Corporation, Armonk, NY (US)

(72) Inventors: Vinod K. Srivastava, Pune (IN); Rekha Yadav, Pune (IN)

(21) Appl. No.: 14/630,940

(22) Filed: Feb. 25, 2015

(51) Int. Cl. G06K 9/00; G06Q 20/04

(52) U.S. Cl. CPC G06K 9/00442; G06Q 20/0453

(57) ABSTRACT

Individuals are protected from monetary loss, due to fraudulent banknotes and faulty record-keeping, through the use of currency-ownership identification based on banknote serial numbers. Individuals transacting in banknotes receive a receipt showing the serial numbers, as a string of text, of some or all banknotes involved in the transaction as proof of ownership and source.

### BACKGROUND OF THE INVENTION

The present invention relates generally to the field of economics, and more particularly to tracking of currency.

Counterfeit banknotes are generally produced with identical serial numbers or with serial numbers that are sequential. Some central banks will issue advisory notices regarding banknote serial number sequences subject to counterfeiting. In addition, some central banks have stopped the practice of bundling banknotes with sequential serial numbers due to the prevalence of counterfeit banknotes with sequential serial numbers.

Based on this information, financial institutions have made strides in the detection and elimination of counterfeit banknotes. Some financial institutions scrutinize deposits containing banknotes with sequential serial numbers and/or with serial numbers flagged by government authorities as potentially counterfeit. Financial institutions have also taken steps to determine the immediate source of these counterfeit banknotes, to adjust the account balances of those accounts associated with the counterfeit banknotes.

In some countries, financial institutions have found counterfeit banknotes, purporting to be the equivalent of millions of U.S. dollars, in bank safes. Central banks in these countries have issued guidelines to curb the impact of counterfeit banknotes, and financial institutions in those countries are taking strong steps to adhere to the issued guidelines.

### SUMMARY

According to an aspect of the present invention, there is a method, computer program product, and/or system that performs the following steps (not necessarily in the following order): (i) locating a serial number of a banknote; (ii) scanning the serial number as a string of text; (iii) generating a receipt that includes the string of text; and (iv) transmitting the receipt. At least the scanning step is performed by computer software running on computer hardware.

### BRIEF DESCRIPTION OF THE DRAWINGS

FIG. 1 is a block diagram view of a first embodiment of a system according to the present invention;

FIG. 2 is a flowchart showing a first embodiment method performed, at least in part, by the first embodiment system;

FIG. 3 is a block diagram view of a machine logic (for example, software) portion of the first embodiment system;

FIG. 4 is a flowchart showing a second embodiment method according to the present invention;

FIG. 5 is a flowchart showing a third embodiment method according to the present invention;

FIG. 6 is a block diagram view of a second embodiment of a system according to the present invention;

FIG. 7 is a flowchart showing a fourth embodiment method performed, at least in part, by the second embodiment system; and

FIG. 8 is a diagram view depicting a banknote according to an embodiment of the present invention that is helpful in understanding embodiments of the present invention.

### DETAILED DESCRIPTION

Individuals are protected from monetary loss, due to fraudulent banknotes and faulty record-keeping, through the use of currency-ownership identification based on banknote serial numbers. Individuals transacting in banknotes receive a receipt showing the serial numbers, as a string of text, of some or all banknotes involved in the transaction as proof of ownership and source. This Detailed Description section is divided into the following sub-sections: (i) The Hardware and Software Environment; (ii) Example Embodiment; (iii) Further Comments and/or Embodiments; and (iv) Definitions.

### I. THE HARDWARE AND SOFTWARE ENVIRONMENT

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It is understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

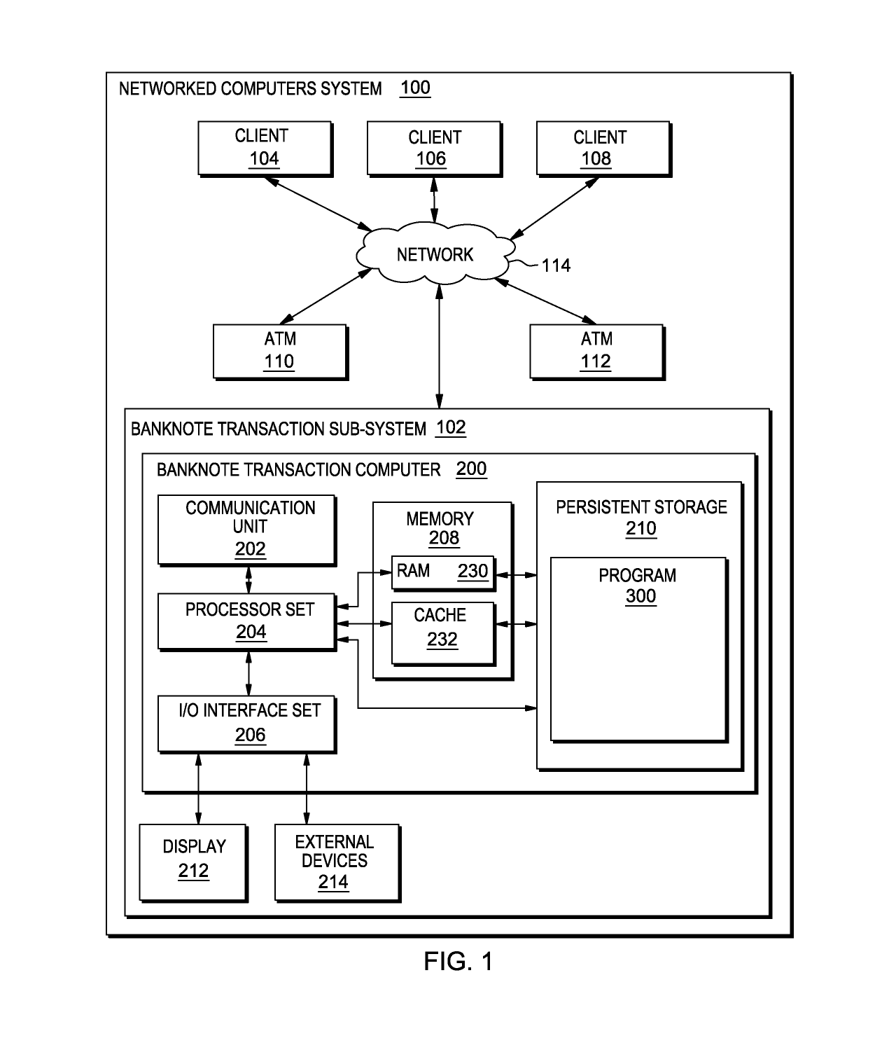

An embodiment of a possible hardware and software environment for software and/or methods according to the present invention will now be described in detail with reference to the Figures. FIG. 1 is a functional block diagram illustrating various portions of networked computers system 100, including: banknote transaction sub-system 102; client sub-systems 104, 106, 108; automated teller machines (ATMs) 110, 112; communication network 114; banknote transaction computer 200; communication unit 202; processor set 204; input/output (I/O) interface set 206; memory device 208; persistent storage device 210; display device 212; external device set 214; random access memory (RAM) devices 230; cache memory device 232; and program 300.

Sub-system 102 is, in many respects, representative of the various computer sub-system(s) in the present invention. Accordingly, several portions of sub-system 102 will now be discussed in the following paragraphs.

Sub-system 102 may be a laptop computer, tablet computer, netbook computer, personal computer (PC), a desktop computer, a personal digital assistant (PDA), a smart phone, or any programmable electronic device capable of communicating with the client sub-systems via network 114. Program 300 is a collection of machine readable instructions and/or data that is used to create, manage and control certain software functions that will be discussed in detail, below, in the Example Embodiment sub-section of this Detailed Description section.

Sub-system 102 is capable of communicating with other computer sub-systems via network 114. Network 114 can be, for example, a local area network (LAN), a wide area network (WAN) such as the Internet, or a combination of the two, and can include wired, wireless, or fiber optic connections. In general, network 114 can be any combination of connections and protocols that will support communications between server and client sub-systems.

Sub-system 102 is shown as a block diagram with many double arrows. These double arrows (no separate reference numerals) represent a communications fabric, which provides communications between various components of sub-system 102. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 208 and persistent storage 210 are computer-readable storage media. In general, memory 208 can include any suitable volatile or non-volatile computer-readable storage media. It is further noted that, now and/or in the near future: (i) external device(s) 214 may be able to supply, some or all, memory for sub-system 102; and/or (ii) devices external to sub-system 102 may be able to provide memory for sub-system 102.

Program 300 is stored in persistent storage 210 for access and/or execution by one or more of the respective computer processors 204, usually through one or more memories of memory 208. Persistent storage 210: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 210.

Program 300 may include both machine readable and performable instructions and/or substantive data (that is, the type of data stored in a database). In this particular embodiment, persistent storage 210 includes a magnetic hard disk drive. To name some possible variations, persistent storage 210 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 210 may also be removable. For example, a removable hard drive may be used for persistent storage 210. Other examples include optical and magnetic disks, thumb drives, and smart cards that are inserted into a drive for transfer onto another computer-readable storage medium that is also part of persistent storage 210.

Communications unit 202, in these examples, provides for communications with other data processing systems or devices external to sub-system 102. In these examples, communications unit 202 includes one or more network interface cards. Communications unit 202 may provide communications through the use of either or both physical and wireless communications links. Any software modules discussed herein may be downloaded to a persistent storage device (such as persistent storage device 210) through a communications unit (such as communications unit 202).

I/O interface set 206 allows for input and output of data with other devices that may be connected locally in data communication with server computer 200. For example, I/O interface set 206 provides a connection to external device set 214. External device set 214 will typically include devices such as a keyboard, keypad, a touch screen, and/or some other suitable input device. External device set 214 can also include portable computer-readable storage media such as, for example, thumb drives, portable optical or magnetic disks, and memory cards. Software and data used to practice embodiments of the present invention, for example, program 300, can be stored on such portable computer-readable storage media. In these embodiments the relevant software may (or may not) be loaded, in whole or in part, onto persistent storage device 210 via I/O interface set 206. I/O interface set 206 also connects in data communication with display device 212.

Display device 212 provides a mechanism to display data to a user and may be, for example, a computer monitor or a smart phone display screen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

### II. EXAMPLE EMBODIMENT

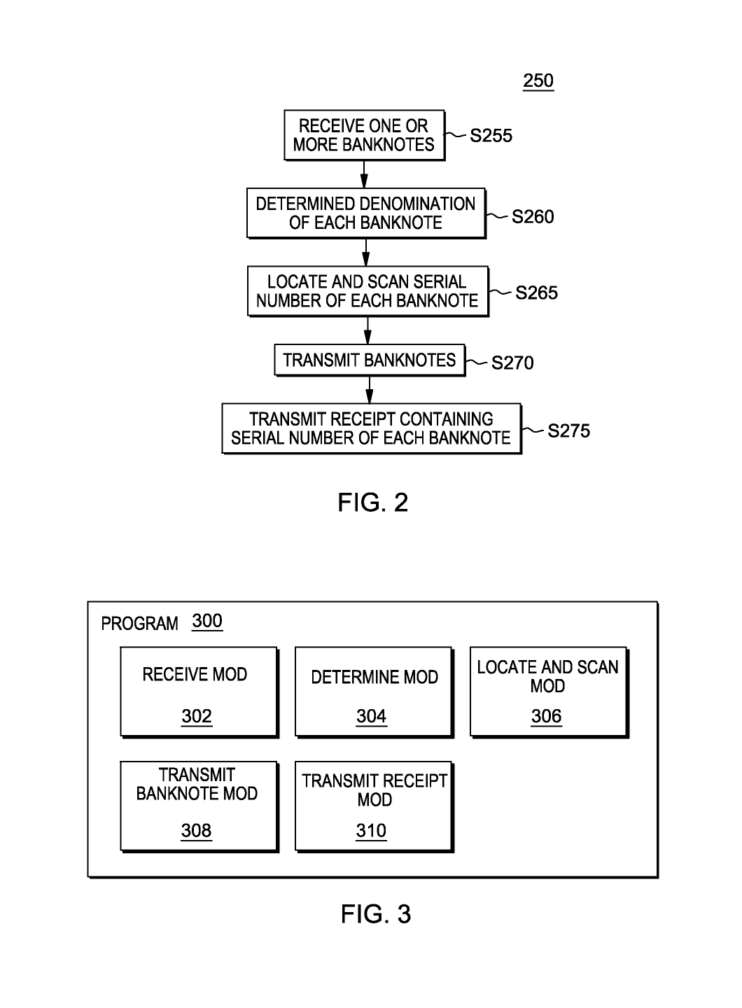

FIG. 2 shows flowchart 250 depicting a method according to the present invention. FIG. 3 shows program 300 for performing at least some of the method steps of flowchart 250. This method and associated software will now be discussed, over the course of the following paragraphs, with extensive reference to FIG. 1 (for the system diagram), FIG. 2 (for the method step blocks), and FIG. 3 (for the software blocks). In this example, banknote transaction sub-system 102 is an ATM, which contains program 300, and Able, a bank customer, deposits banknotes. Alternatively, banknote transaction sub-system 102 may be, but is not limited to, a laptop computer, tablet computer, netbook computer, personal computer (PC), a desktop computer, a personal digital assistant (PDA), or a smart phone.

Processing begins at step S255, where receive module (“mod”) 302 receives one or more banknotes in physical form. In this example, when Able inserts banknote 800 (FIG. 8) into the ATM, receive mod 302 operates on external devices 214, into which the banknote is inserted. Alternatively, the banknote is received directly from Able. Alternatively, the banknote is received from a network connected machine, such as ATM 110, that communicates with program 300.

Processing proceeds to step S260, where determine mod 304 determines the denomination for banknote 800, received in step S255. In some embodiments, the determine mod individually inspects the banknote and determines the denomination of the banknote. In this example, the determine mod operates on external devices 214, which physically and optically analyzes the banknote to determine a corresponding denomination. Alternate methods of determining the denomination of the banknote include: (i) reference to security features on the banknote; (ii) reference to the dimensions of the banknote; (iii) analyzing the color of the banknote; (iv) optical analysis of the banknote; and (v) user entry of the denomination of the banknote at the time of deposit. In some embodiments of the present invention, the denomination of the banknote determines the degree of processing to be performed. Further, discussion of a denomination-specific process is provided in Section III of this Detailed Description.

Processing proceeds to step S265, where locate and scan mod 306 locates and scans a serial number, as a string of text, for banknote 800, received in S255. In this example, the locate and scan mod operates on external devices 214, which locates a serial number on the banknote. Further, once the serial number is located, the locate and scan mod operates on the external devices, which scan the banknote and create a digital image of the banknote. Still further, the locate and scan mod operates on I/O interface set 206 to convert the image of the serial number into a string of text and saves the string to memory 208. Alternatively, the location of the serial number on the banknote is determined by the denomination of the banknote, as determined in step S260. Alternatively, the location of the serial number on the banknote is determined by the currency of the banknote, as determined in step S260. Alternatively, the location of the serial number is preset. Alternatively, a device containing an OCR program determines the location of the serial number on the banknote. Alternatively, the device containing the OCR program scans the banknote.

Processing proceeds to step S270, where transmit banknotes mod 308 transmits banknote 800, received in step S255. In this example, the transmit banknotes mod operates on external devices 214 to transmit the banknote within ATM 102 where the banknote is stored. Alternatively, the banknote is transmitted to Baker, a second bank customer. Alternatively, the banknote is transmitted from a network connected machine, such as ATM 110, that communicates with program 300.

Processing ends at step S275, where transmit receipt mod 310 transmits a receipt including the banknote information obtained in step S265. In this example, the transmit receipt mod operates on display 212 to generate a visual receipt and on external devices 214 to generate a paper receipt. The generated receipts, both visual and paper, display as output the string stored to memory 208 in step S265. Alternatively, the transmit receipt mod operates on the external devices to transmit a receipt via SMS protocol over network 114 to client 104, which is Able's smartphone. Alternatively, the receipt is transmitted via email to Able's email address. Alternatively, multiple receipts are generated and transmitted via multiple means. Alternatively, duplicate receipts are generated and transmitted, one to Able and one to Able's bank. In some embodiments, the banknote information and some identifying information about Able, provided by Able as input, are temporarily stored to the memory. Alternatively, the identifying information about Able is based on Able's account information. Alternatively, the receipt is transmitted to the user's banking website.

### III. FURTHER COMMENTS AND/OR EMBODIMENTS

Some embodiments of the present invention recognize one or more of the following facts, potential problems, and potential areas for improvement with respect to the current state of the art: (i) because of the actions of financial institutions, some individuals in possession of counterfeit banknotes have experienced monetary loss through no fault of their own; (ii) individuals have received counterfeit banknotes from a financial institution, either through an ATM or from a less observant teller; (iii) individuals have unknowingly received counterfeit banknotes during transactions and have subsequently attempted to deposit those counterfeit banknotes in their bank accounts; (iv) the existing guidelines issued by central banks do not address issues encountered by individuals during some transactions involving banknotes; (v) even when financial institutions follow the published guidelines, ATM transactions have become a point of concern for some individuals; and (vi) current solutions are insufficient to protect the interests of affected individuals.

Some embodiments of the present invention recognize one or more of the following facts, potential problems, and potential areas for improvement with respect to the current state of the art: (i) financial institutions have incorrectly debited the accounts of individuals after ATM transactions during which the individuals did not withdraw banknotes; (ii) there is no current solution to issues facing individuals who encounter counterfeit banknotes received from ATMs; and (iii) current solutions for improper debiting of accounts by financial institutions have an extended turnaround time and are dependent upon the manner in which each financial institution handles erroneous transactions.

Some embodiments of the present invention recognize one or more of the following facts, potential problems, and potential areas for improvement with respect to the current state of the art: (i) the problem of counterfeit banknotes is more prevalent with respect to banknotes having higher denominations within that currency (e.g., US$100, INR [symbol] 500, etc.); (ii) printing images on paper requires a large amount of space and/or requires condensing the image to an unreadably small size; (iii) some individuals initiate transactions involving large quantities of banknotes; (iv) individuals will lose patience during long delays to withdraw or deposit banknotes; (v) issues faced at ATMs are similar to issues encountered at other locations where banknotes are used; and (vi) techniques used to validate banknotes must be updated as security features embedded in banknotes change.

There have been occurrences of an individual withdrawing a counterfeit banknote from an ATM. At a later transaction, that same counterfeit banknote is dishonored and/or destroyed. The individual has no method of proving the source of the counterfeit banknote, resulting in a monetary loss to the individual. There have also been occurrences of an individual unknowingly receiving a counterfeit banknote during a transaction and depositing that counterfeit banknote with a financial institution, either in an ATM or with a teller. When the counterfeit banknote is discovered, the financial institution does not credit the individual's account with the deposit of the counterfeit banknote and the individual has no method of proving the source of the counterfeit banknote, resulting in a monetary loss to the individual.

In addition to these issues, there have also been occurrences of faulty record-keeping during ATM transactions. An individual completed an ATM transaction during which no banknotes were withdrawn from the ATM; however, the financial institution later debited the individual's account, resulting in a monetary loss to the individual.

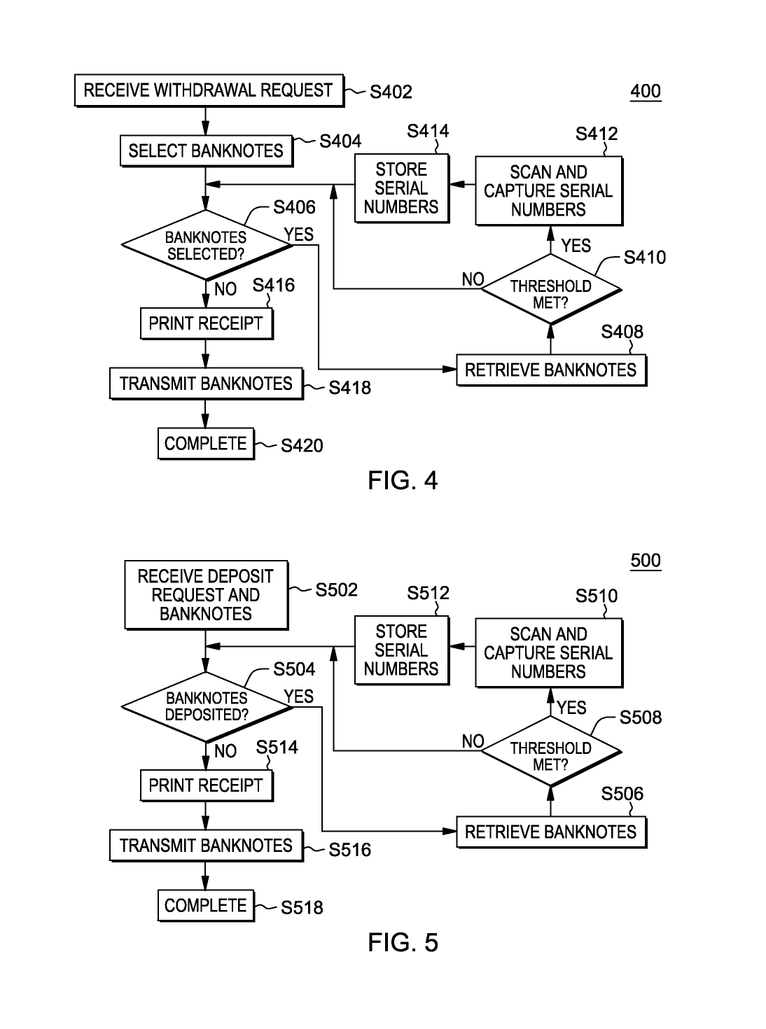

FIG. 4 shows flowchart 400 depicting a method according to the present invention. To better understand flowchart 400, an example will be referred to throughout the description. In this example, an individual looks to withdraw US$300 in banknotes from an ATM.

Processing begins at step S402, where a withdrawal request is initiated. In this example, the withdrawal request is for US$300 in banknotes from an ATM, such as ATM 110 (FIG. 1).

Processing proceeds to step S404, where banknotes are selected to match the amount requested in step S402. In this example, the denominations of the selected banknotes are preset. For a withdrawal of US$300, the banknotes selected are two US$100 banknotes, one US$50 banknote, two US$20 banknotes, and one US$10 banknote. Alternatively, there will only be a single denomination of banknotes available for selection. Alternatively, there is a limited amount of one or more denominations of banknotes available for selection. Alternatively, the withdrawal request will include a request for certain denominations of banknotes.

Processing proceeds to decision step S406, where it is decided whether one or more banknotes are selected for dispensing. If one or more banknotes are selected for dispensing, processing proceeds through the “Yes” branch. If there are no banknotes selected for dispensing, processing proceeds through the “No” branch. In this example, six banknotes were selected, therefore processing proceeds through the “Yes” branch.

Following the “Yes” branch from step S406, processing proceeds to step S408, where each banknote identified in step S404 is retrieved individually. In this example, the first banknote retrieved from the ATM is one US$100 banknote. Alternatively, banknotes identified in step S404 of the same denomination would be retrieved substantially concurrently. Alternatively, banknotes identified in step S404 would be retrieved substantially concurrently.

Processing proceeds to decision step S410, where it is decided whether the denomination of each individual banknote meets a threshold value. If the denomination of the individual banknote is below the threshold value, processing proceeds through the “No” branch. If the denomination of the banknote is equal to or greater than the threshold value, processing proceeds through the “Yes” branch. In this example, the threshold is preselected at US$50. Alternatively, the threshold value is input at the time of the withdrawal request. Alternatively, there is no threshold value.

Following the “No” branch from step S410, processing returns to step S406 where any remaining banknotes selected for dispensing are processed. In this example, this “No” branch from step S410 is not taken for the two US$100 banknotes or for the US$50 banknote, but is taken for the two US$20 banknotes and for the US$10 banknote.

Following the “Yes” branch from step S410, processing proceeds to step S412, where the serial number of the individual banknote is scanned. In this example, the US$100 banknote is scanned for a serial number, which appears in the general vicinity of each of 804a and 804d, as portrayed in FIG. 8. Alternatively, for pre-1996 series United States banknotes and for US$1 banknotes, the serial number appears in the general vicinity of 804b and 804c. In this example, the serial number for the US$100 banknote is “MB00000001A.”

Processing proceeds to step S414, where the banknote information is stored in memory as a string of text. Banknote information includes, but is not limited to, the denomination of the banknote and the serial number of the banknote. In this example, the banknote information for the first US$100 banknote would be the denomination “US$100” and the serial number “MB00000001A.” This banknote information is stored locally in the ATM. Alternatively, the banknote information is stored on a server. Processing returns to step S406 where any remaining banknotes selected for dispensing are processed. In this example, step S406 proceeds for each of the remaining banknotes: one US$100 banknote, one US$50 banknote, two US$20 banknotes, and one US$10 banknote. Alternatively, banknote information may also include the banknote series, the central bank location (branch and/or district) at which the banknote was printed, the serial number of the plate used to print to obverse of the banknote, the serial number of the plate used to print the reverse of the banknote, and the banknote's position on the plates.

Following the “No” branch from step S406, processing proceeds to step S416, where a receipt is printed containing at least some of the banknote information stored during step S414. In this example, a paper receipt is printed with the serial numbers of the banknotes. Alternatively, all banknote information is printed. Alternatively, a receipt is transmitted via SMS protocol. Alternatively, a receipt is transmitted via email. Alternatively, transmission of the receipt will always occur via a paper receipt. Alternatively, the manner of transmission of the receipt is input with the withdrawal request. Alternatively, the banknote information to be printed is input with the withdrawal request. In some embodiments, the SMS address and/or email address are input with the withdrawal request. In some embodiments, the SMS address and/or email address are determined based on the user's account information. In some embodiments, the receipt is also transmitted to the user's bank.

Processing proceeds to step S418, where the banknotes selected in step S404 are transmitted. In this example, the six banknotes are transmitted through the ATM for delivery to the individual that initiated the withdrawal request. Processing ends at step S420.

FIG. 5 shows flowchart 500 depicting a method according to the present invention. To better understand flowchart 500, an example will be referred to throughout the description. In this example, an individual looks to deposit US$300 in banknotes into the individual's account via an ATM, such as ATM 112 (FIG. 1).

Processing begins at step S502, where a deposit request is submitted and banknotes are deposited. In this example, the deposit request is for US$300 in banknotes into an ATM. In this example, the denominations of the banknotes deposited are two US$100 banknotes, one US$50 banknote, two US$20 banknotes, and one US$10 banknote.

Processing proceeds to decision step S504, where it is decided whether one or more banknotes are deposited. If one or more banknotes are deposited, processing proceeds through the “Yes” branch. If there are no banknotes deposited, processing proceeds through the “No” branch. In this example, six banknotes were deposited, therefore processing proceeds through the “Yes” branch.

Following the “Yes” branch from step S504, processing proceeds to step S506, where each banknote deposited in step S502 is retrieved individually. In this example, the first banknote retrieved from the ATM is one US$100 banknote. Alternatively, banknotes deposited in step S502 of the same denomination would be retrieved substantially concurrently. Alternatively, banknotes deposited in step S502 would be retrieved substantially concurrently.

Processing proceeds to decision step S508, where it is decided whether the denomination of each individual banknote meets a threshold value. If the denomination of the individual banknote is below the threshold value, processing proceeds through the “No” branch. If the denomination of the banknote is equal to or greater than the threshold value, processing proceeds through the “Yes” branch. In this example, the threshold is preselected at US$50. Alternatively, the threshold value is input at the time of the withdrawal request. Alternatively, there is no threshold value.

Following the “No” branch from step S508, processing returns to step S504 where any remaining banknotes deposited are processed. In this example, this “No” branch from step S508 is not taken for the two US$100 banknotes or for the US$50 banknote, but is taken for the two US$20 banknotes and for the US$10 banknote.

Following the “Yes” branch from step S508, processing proceeds to step S510, where the serial number of the individual banknote is scanned. In this example, the US$100 banknote is scanned for a serial number, which appears in the general vicinity of each of 804a and 804d, as portrayed in FIG. 8. Alternatively, for pre-1996 series United States banknotes and for US$1 banknotes, the serial number appears in the general vicinity of 804b and 804c. In this example, the serial number for the US$100 banknote is “MB00000001A.”

Processing proceeds to step S512, where the banknote information is stored in memory as a string of text. Banknote information includes, but is not limited to, the denomination of the banknote and the serial number of the banknote. In this example, the banknote information for the first US$100 banknote is the denomination “US$100” and the serial number “MB00000001A.” This banknote information is stored locally in the ATM. Alternatively, the banknote information is stored on a server. Processing returns to step S504 where any remaining banknotes selected for dispensing are processed. In this example, step S504 proceeds for each of the remaining banknotes: one US$100 banknote, one US$50 banknote, two US$20 banknotes, and one US$10 banknote.

Following the “No” branch from step S504, processing proceeds to step S514, where a receipt is printed containing at least some of the banknote information stored during step S512. In this example, a paper receipt is printed. Alternatively, a receipt is transmitted via SMS protocol. Alternatively, a receipt is transmitted via email. Alternatively, transmission of the receipt will always occur via a paper receipt. Alternatively, the manner of transmission of the receipt is input with the withdrawal request. In some embodiments, the SMS address and/or email address are input with the withdrawal request. In some embodiments, the SMS address and/or email address are determined based on the user's account information. In some embodiments, the receipt is also transmitted to the user's bank.

Processing proceeds to step S516, where the banknotes deposited in step S502 are transmitted. In this example, the six banknotes are transmitted through the ATM for deposit into the account of the individual that submitted the deposit request. Processing ends at step S518.

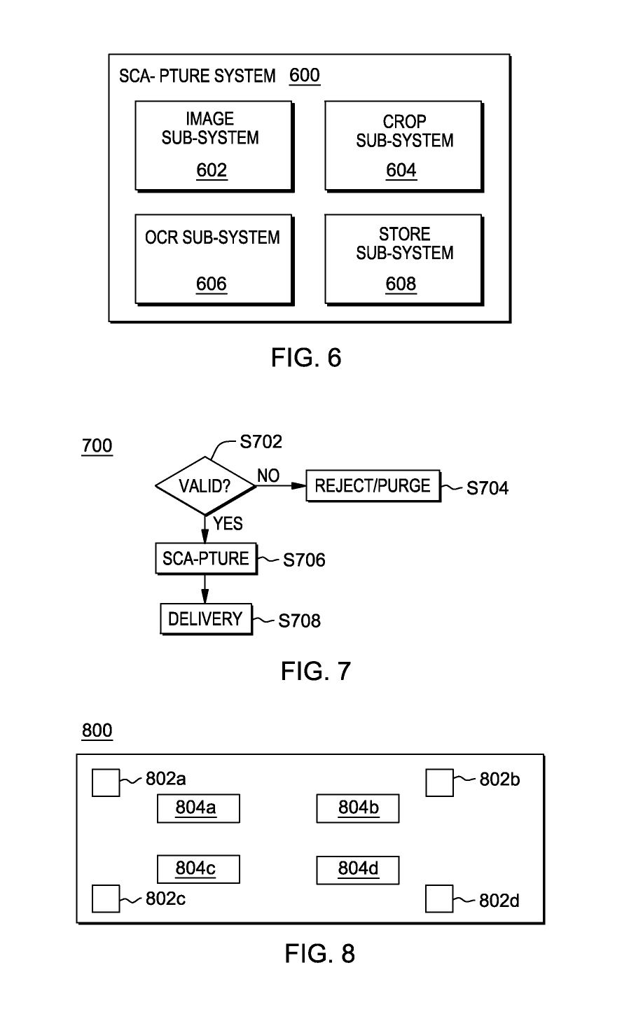

FIG. 6 is a functional block diagram illustrating various portions of sca-pture system 600. Sca-pture system 600 may be any piece of hardware, or system of connected pieces of hardware, capable of scanning and capturing an image, cropping and storing the image, and using optical character recognition (OCR) to read alphanumeric characters from the image. FIG. 7 shows flowchart 700 depicting a method according to one embodiment of the present invention. This system will now be discussed, over the course of the following paragraphs, with extensive reference to FIG. 6 (for the software blocks) and FIG. 7 (for the method step blocks).

Processing begins at decision step S702, where it is decided whether each banknote is valid. If the banknote is valid, processing proceeds through the “Yes” branch. If the banknote is not valid, processing proceeds through the “No” branch.

Following the “No” branch from step S702, processing ends at step S704, where invalid banknotes are rejected or purged. Reasons for banknote invalidity include, but are not limited to, improper physical dimensions, missing or incorrect security features, mutilated or mangled banknotes, and/or being counterfeit.

Following the “Yes” branch from step S702, processing proceeds to step S706, where sca-pture system 600 is operated to protect individuals from monetary loss, due to fraudulent banknotes and faulty record-keeping, using currency-ownership identification based on banknote serial numbers. Alternatively, step S706 operates the method steps S406-S414 (FIG. 4) as described above.

Sca-pture system 600 includes: image sub-system 602; crop sub-system 604; OCR sub-system 5606; and store sub-system 608.

Image sub-system 602 is an electronic device capable of capturing a digital image of a physical banknote.

Crop sub-system 604 crops the digital image captured by image sub-system 602 for processing of the serial number by OCR sub-system 606.

OCR sub-system 606 converts the image cropped by crop sub-system 604 to a string of text.

Store sub-system 608 stores the string of text created by OCR sub-system 606 to memory 208 (FIG. 2).

Processing ends at step S708, where banknotes and a receipt, bearing the serial numbers of the banknotes processed in step S706, are transmitted.

FIG. 8 shows diagram 800 depicting an exemplar banknote. In this example, diagram 800 depicts the obverse of a United States banknote. Alternatively, the obverse of any banknote may be depicted. Alternatively, the reverse of any banknote may be depicted.

Block 802, depicted on diagram 800 as four blocks 802a, 802b, 802c, and 802d, represents the general location of a denomination indicator on a banknote. In this example, each of the four 802 blocks indicate the denomination of the United States banknote. Alternatively, other banknotes may indicate the denomination in one or more of the 802 blocks. Alternatively, other banknotes may indicate the denomination in different positions on the banknote. Alternatively, other banknotes may indicate the denomination on only the obverse of the banknote. Alternatively, other banknotes may indicate the denomination on only the reverse of the banknote

Block 804, depicted on diagram 800 as four blocks 804a, 804b, 804c, and 804d, represents the general location of a serial number on a banknote. In this example, only two of the four 804 blocks indicate the serial number of the United States banknote. For pre-1996 series United States banknotes, and for US$1 banknotes, the serial number is indicated in blocks 804b and 804c. For other United States banknotes, the serial number is indicated in blocks 804a and 804d. Alternatively, other banknotes may indicate the serial number in one or more of the 804 blocks. Alternatively, other banknotes may indicate the serial number in different positions on the banknote. Alternatively, other banknotes may indicate the serial number on only the obverse of the banknote. Alternatively, other banknotes may indicate the serial number on only the reverse of the banknote.

Some embodiments of the present invention may include one, or more, of the following features, characteristics, and/or advantages: (i) determining the denomination of a banknote; (ii) determining the currency of the banknote; (iii) determining whether a banknote is valid; (iv) locating the serial number of a banknote; (v) scanning the serial number of a banknote as a string of text; (vi) temporarily storing the serial numbers of banknotes as a string of text in a digital medium; (vii) generating a receipt that includes the serial number as a string of text; (viii) transmitting a receipt containing the serial number of each banknote; and (ix) assigning temporary ownership of a banknote in short-term memory.

Some embodiments of the present invention may include one, or more, of the following features, characteristics, and/or advantages: (i) preselecting or receiving as an input a threshold denomination for which a receipt containing the serial number of each banknote for a given transaction is printed; (ii) sorting banknote serial numbers by the denomination of the banknotes from which the serial numbers were taken; (iii) retrieving a user's SMS or email address based on account information; (iv) receiving a user's SMS or email address as an input; (v) sorting the banknote serial numbers in alphanumeric order; (vi) transmitting digital copies of the receipt using SMS protocol and/or email; (vii) transmitting a receipt containing no banknote serial numbers for transactions not involving banknotes; (viii) transmitting a receipt for transactions at point-of-sale locations; (ix) transmitting copies of the receipt for each user involved in a transaction; and (x) transmitting a receipt containing the serial number of each banknote involved in a transaction with an ATM.

Some embodiments of the present invention may include one, or more, of the following features, characteristics, and/or advantages: (i) allows an individual to prove the source of the counterfeit banknote and shift liability for the monetary loss to the responsible party; (ii) allows financial institutions and government authorities to more easily locate the origin of counterfeit banknotes; (iii) by printing a receipt containing no serial numbers, an individual can reduce the turnaround time for occurrences in which a financial institution has improperly debited that individual's account; (iv) using new OCR software, which is faster and more efficient than prior versions of character recognition software, to determine the serial numbers of each banknote involved in a transaction; (v) short-term storage of banknote-ownership information, which is more efficient than long-term storage; (vi) OCR scanning of the banknote serial number provides for a transmission of a text-based receipt via SMS protocol; and (vii) OCR scanning of the banknote serial number provides for a transmission of a text-based receipt via email having reduced memory size compared to that of a scanned image based receipt.

Some embodiments of the present invention will include an electronic device to determine the denomination of each banknote. Some embodiments of the present invention will include an electronic device to scan each banknote and record the serial number of the scanned banknotes as a string of text. Some embodiments of the present invention will include an electronic device to store the serial numbers scanned from each banknote. In some embodiments of the present invention, scanning of the serial number will occur substantially concurrently with the determination of the denomination of the banknote. In some embodiments of the present invention, the device to locally store serial numbers will retain serial number information to compare the serial number of new banknotes against the serial numbers for which the device already has information. Some embodiments of the present invention will include an electronic device to verify the authenticity of banknotes.

Optical character recognition (OCR) is the process by which an image file is converted into a string of text. If the target for conversion is not in a digital format, a scanner is generally needed to create a digital image file. Once in a digital format, the OCR process can locate characters that appear in the image and create a string of text consisting of the located characters. The OCR process can then save the string of text to a word processor or pass the string of text to another process. In some embodiments, the OCR process is tuned to recognize a predefined font and character set, including color and font size, for faster pattern matching and character recognition. In some embodiments, the digital image file is cropped to a known area, removing extraneous characters and optimizing the speed of the OCR process.

The process of assigning temporary ownership to a banknote consists of saving the banknote information and identifying information about the user to a local memory for a period of time. Embodiments of the present invention recognize that banknotes undergo numerous transactions and that for some transactions, temporary assignment of ownership may not occur. Therefore, the purpose of assigning temporary ownership to a banknote is to assist in shifting liability away from individuals who were impacted by counterfeit banknotes. The period of time during which a memory will retain the banknote information and the identifying information about the user may fluctuate, but is substantial enough to afford the user protection in the event a banknote is counterfeit. Alternatively, the temporary ownership information is also sent to the user's bank for recording and validation. Alternatively, the temporary ownership information is also sent to the user's bank for analytic purposes.

### IV. DEFINITIONS

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

User/subscriber: includes, but is not necessarily limited to, the following: (i) a single individual human; (ii) an artificial intelligence entity with sufficient intelligence to act as a user or subscriber; and/or (iii) a group of related users or subscribers.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (FPGA) based devices, smart phones, personal digital assistants (PDAs), body-mounted or inserted computers, embedded device style computers, application-specific integrated circuit (ASIC) based devices.

Banknote: any paper currency or paper-like currency (e.g., currency made of, comprising, or incorporating polymers), issued by the central bank of any one or more countries or the central bank of a collective of countries.

What is claimed is:

1. A method comprising:
locating a set of serial numbers corresponding to a set of banknotes;
scanning, by an optical character recognition process, the set of serial numbers corresponding to the set of banknotes as a string of text, wherein the string of text is not an image;
generating a receipt that includes the string of text; and
transmitting the receipt;
wherein:
at least the scanning step is performed by computer software running on computer hardware.

2. The method of claim 1, wherein the transmitting step includes transmission by SMS protocol.

3. (canceled)

4. The method of claim 1, wherein the locating step is performed based on a known location of the set of serial numbers.

5. The method of claim 1, further comprising:
assigning temporary ownership to the set of banknotes.

6. The method of claim 1, further comprising:
deciding whether the set of banknotes is valid.

7. The method of claim 1, further comprising:
determining a denomination corresponding to the set of banknotes.

8. A computer program product comprising a computer readable storage medium having stored thereon:
first program instructions programmed to locate a serial number of a banknote;
second program instructions programmed to scan the serial number as a string of text;
third program instructions programmed to generate a receipt that includes the string of text; and
fourth program instructions programmed to transmit the receipt.

9. The computer program product of claim 8, wherein the fourth program instructions further include transmitting the receipt by SMS protocol.

10. The computer program product of claim 8, wherein the second program instructions further include scanning the serial number as a string of text using an optical character recognition process.

11. The computer program product of claim 8, further comprising:
fifth program instructions programmed to assign temporary ownership to the banknote.

12. The computer program product of claim 8, further comprising:
fifth program instructions programmed to decide whether the banknote is valid.

13. The computer program product of claim 8, further comprising:
fifth program instructions programmed to determine a denomination of the banknote.

14. A computer system comprising:
a processor(s) set; and
a computer readable storage medium;
wherein:
the processor(s) set is structured, located, connected, and/or programmed to run program instructions stored on the computer readable storage medium; and
the program instructions include:
first program instructions programmed to locate a serial number of a banknote;
second program instructions programmed to scan the serial number as a string of text;
third program instructions programmed to generate a receipt that includes the string of text; and
fourth program instructions programmed to transmit the receipt by SMS protocol.

15. (canceled)

16. The computer system of claim 14, wherein the second program instructions further include scanning the serial number as a string of text using an optical character recognition process.

17. The computer system of claim 16, wherein the first program instructions further include locating a serial number of a banknote based on a known location of the serial number.

18. The computer system of claim 14, further comprising:
fifth program instructions programmed to assign temporary ownership to the banknote.

19. The computer system of claim 14, further comprising:
fifth program instructions programmed to decide whether the banknote is valid.

20. The computer system of claim 14, further comprising:
fifth program instructions programmed to determine a denomination of the banknote.

21. The computer program product of claim 10, wherein the first program instructions further include locating a serial number of a banknote based on a known location of the serial number.
